(19) United States
(12) Patent Application Publication
(10) Pub. No.: US 2020/0335241 A1
(43) Pub. Date: Oct. 22, 2020

(54) Cable and A Combined Cable

(71) Applicants: Tyco Electronics (Shanghai) Co. Ltd., Shanghai (CN); TE Connectivity Services GmbH, Schaffhausen (CH)

(72) Inventors: Hainan Lu, Dongguan (CN); Wei Yao, Kunshan (CN); Kevin Edward Weidner, Middletown, PA (US)

(73) Assignees: Tyco Electronics (Shanghai) Co. Ltd., Shanghai (CN); TE Connectivity Services GmbH, Schaffhausen (CH)

(21) Appl. No.: 16/851,237

(22) Filed: Apr. 17, 2020

(30) Foreign Application Priority Data
Apr. 18, 2019 (CN) 201910306182.8

(51) Int. Cl. H01B 7/08; H01B 3/42

(52) U.S. Cl. CPC H01B 7/0807; H01B 7/0869; H01B 3/427

(57) ABSTRACT

A cable includes a pair of wires each having a conductor and a wire insulation layer wrapped around the conductor, an inner insulation layer wrapped around the wire insulation layer of each of the wires and fixing the wires, a metal shielding layer wrapped around an outer surface of the inner insulation layer, and an outer insulation layer wrapped around an outer surface of the metal shielding layer. The metal shielding layer has an insulating substrate and a metal conductive layer coated on the insulating substrate. The metal conductive layer of the metal shielding layer faces the outer insulation layer.

### CROSS-REFERENCE TO RELATED APPLICATION

This application claims the benefit of the filing date under 35 U.S.C. § 119(a)-(d) of Chinese Patent Application No. 201910306182.8, filed on Apr. 18, 2019.

### FIELD OF THE INVENTION

The present invention relates to a cable and, more particularly, to a cable having a pair of wires.

### BACKGROUND

In the prior art, as shown in FIG. 1, a cable structure 10′ of a high-speed cable comprises two wires 1′, one ground wire 5′, a metal shielding layer 3′ being longitudinally wrapped around the two wires 1′ and the one ground wire 5′, and an insulation layer 4′ being then wrapped around the metal shielding layer 3′ to fix the metal shielding layer 3′.

The high-frequency test bandwidth that the cable structure 10′ can achieve, however, is low. Further, the stability is not good and the ground wire 5′ is also easily misaligned during bending of the cable structure 10′.

### SUMMARY

A cable includes a pair of wires each having a conductor and a wire insulation layer wrapped around the conductor, an inner insulation layer wrapped around the wire insulation layer of each of the wires and fixing the wires, a metal shielding layer wrapped around an outer surface of the inner insulation layer, and an outer insulation layer wrapped around an outer surface of the metal shielding layer. The metal shielding layer has an insulating substrate and a metal conductive layer coated on the insulating substrate. The metal conductive layer of the metal shielding layer faces the outer insulation layer.

### BRIEF DESCRIPTION OF THE DRAWINGS

The invention will now be described by way of example with reference to the accompanying Figures, of which:

FIG. 1 is a sectional view of a cable according to the prior art;

FIG. 2 is a sectional view of a cable according to an embodiment of the invention;

FIG. 3 is a sectional view of a combined cable according to an embodiment;

FIG. 4 is a sectional view of a combined cable according to another embodiment; and

FIG. 5 is a sectional view of a combined cable according to another embodiment.

### DETAILED DESCRIPTION OF THE EMBODIMENT(S)

Although the present disclosure will be fully described with reference to the accompanying drawings including embodiments of the disclosure, before the description, it should be understood that modifications may be made to the disclosure herein by those skilled in the art. Therefore, the description is to be understood as a broad disclosure for those skilled in the art, and is not intended to be limited to the exemplary embodiments described herein.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

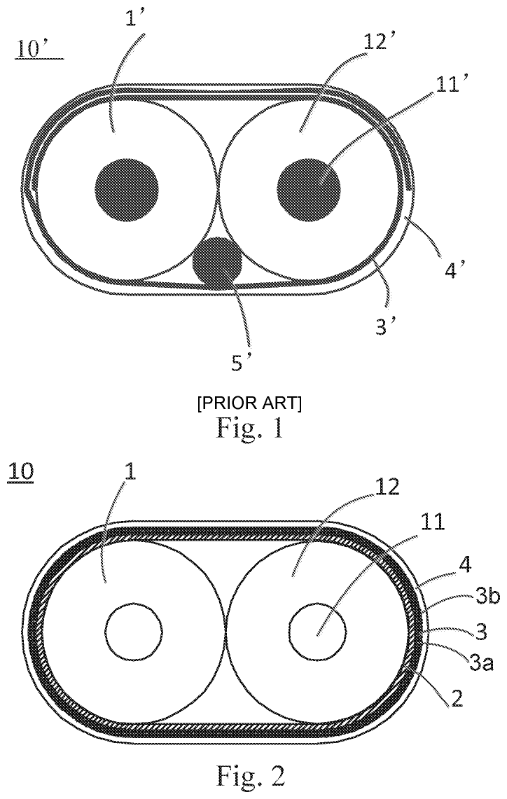

A cable 10 according to an embodiment, as shown in FIG. 2, comprises a pair of wires 1 for transmitting a signal, each of the wires 1 including a conductor 11 and a wire insulation layer 12 wrapped around the conductor 11. The cable 10 also comprises an inner insulation layer 2, a metal shielding layer 3, and an outer insulation layer 4.

As shown in FIG. 2, the inner insulation layer 2 is longitudinally wrapped around the wire insulation layer 12 of the two wires 1 to fix the two wires 1 and prevent the metal shielding layer 3 from entering a gap between the two wires 1. The metal shielding layer 3 is wrapped around an outer surface of the inner insulation layer 2 has an insulation substrate 3a and a metal conductive layer 3b coated to the insulating substrate 3a. The outer insulation layer 4 is wrapped around an outer surface of the metal shielding layer 3, with the metal conductive layer 3b of the metal shielding layer 3 facing the outer insulation layer 4, so that the metal shielding layer 3 can be used as a ground wire, thereby eliminating the separate ground wire and reducing the cost of the entire cable 10. In addition, the high-frequency test bandwidth that the cable 10 can achieve may be more than 40G, and the performance of the cable 10 is more stable.

In the embodiment shown in FIG. 2, the inner insulation layer 2 is suitable for being bonded to outer surfaces of the two wires 1, for example, by hot-melt. In the shown embodiment, the inner insulation layer 2 is made of an insulation polymer material. For example, the inner insulation layer 2 is made of polyethylene terephthalate (“PE” for short).

In the embodiment shown in FIG. 2, the metal shielding layer 3 is suitable for being bonded to the outer surface of the inner insulation layer 2, for example, by hot-melt. That is, the substrate 3a of the metal shielding layer 3 is suitable for being bonded to the outer surface of the inner insulation layer 2, for example, by hot-melt. In an embodiment, the metal conductive layer 3b of the metal shielding layer 3 is made of aluminum or copper. However, it should be noted that those skilled in the art should understand that in some other embodiments of the present disclosure, the metal conductive layer 3b of the metal shielding layer 3 may also be made of other conductive materials.

In the embodiment shown in FIG. 2, the outer insulation layer 4 is suitable for being bonded to the outer surface of the metal shielding layer 3, for example, by hot-melt. The outer insulation layer 4 is made of an insulation polymer material. For example, the outer insulation layer 4 is made of polyethylene terephthalate (“PE” for short). In the shown embodiment, the outer insulation layer 4 is a plurality of sub-insulating layers superimposed on one another. That is, the outer insulation layer 4 may comprise a plurality of sub-insulating layers.

In the embodiment shown in FIG. 2, the cable 10 is flat, so that it can also be referred to as a flat cable.

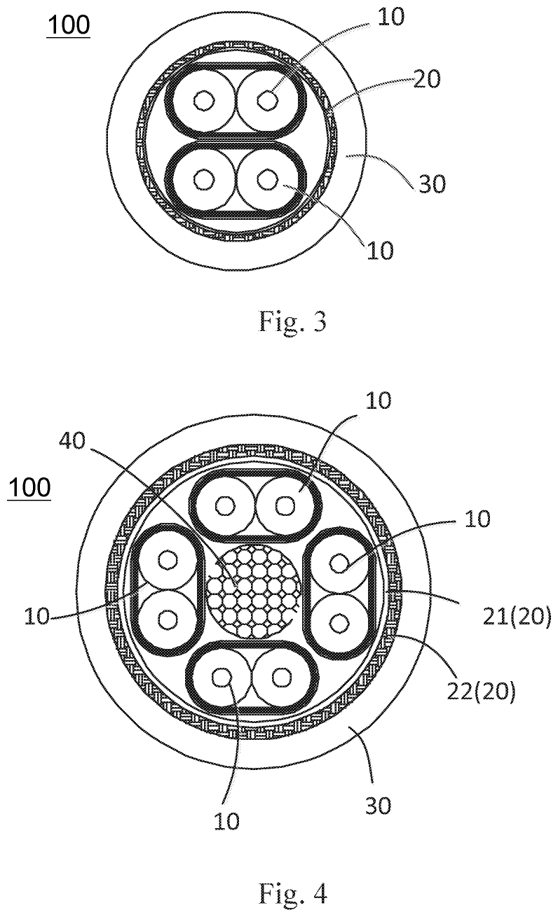

A combined cable 100 according to various embodiments is shown in FIGS. 3-5. The combined cable 100 includes at least a pair of cables 10 and an outer jacket 30 located at an outermost portion of the combined cable 100.

Each of the at least two cables 10, as described with reference to FIG. 2 above, has two wires 1 for transmitting a signal, each of the wires 1 including a conductor 11 and a wire insulation layer 12 wrapped around the conductor 11. The cable 10 also includes an inner insulation layer 2, a metal shielding layer 3, and an outer insulation layer 4. The inner insulation layer 2 is wrapped around the wire insulation layer 12 of the two wires 1 to fix the two wires 1 and preventing the metal shielding layer 3 from entering a gap between the two wires 1. The metal shielding layer 3 wrapped around an outer surface of the inner insulation layer 2 has an insulation substrate 3a and a metal conductive layer 3b coated to the insulating substrate 3a. The outer insulation layer 4 is wrapped around an outer surface of the metal shielding layer 3, the metal conductive layer 3b of the metal shielding layer 3 facing the outer insulation layer 4, so that the metal shielding layer 3 can be used as a ground wire, thereby eliminating the ground wire and reducing the cost of the entire cable 10. In addition, the high-frequency test bandwidth that this cable 10 structure can achieve may be more than 40G, and the performance of the cable 10 is more stable.

The combined cable 100, as shown in FIGS. 3-5, includes a shielding layer 20 wrapped around the at least two cables 10. In the shown embodiments, the shielding layer 20 has an inner shielding layer 21 wrapped around the at least two cables 10 and an outer shielding layer 22 wrapped around the inner shielding layer 21.

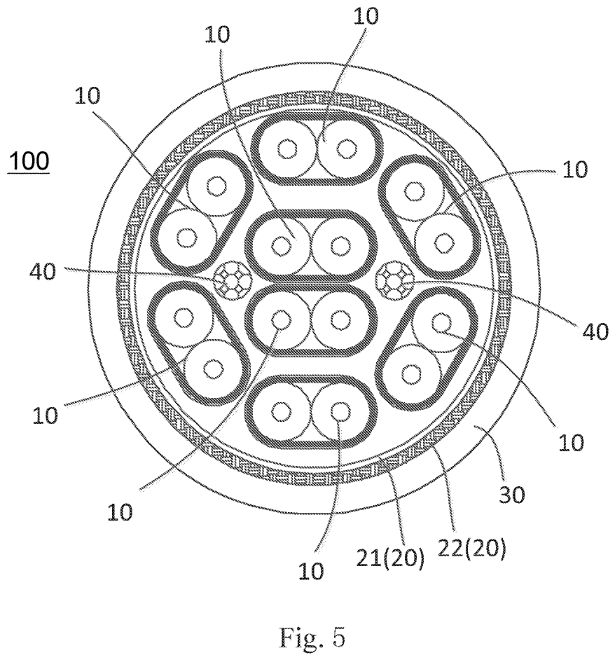

In the embodiments of the combined cable 100 shown in FIGS. 4 and 5, at least one portion of a gap of the at least two cables 10 is filled with a filler 40.

The at least two cables 10, as shown in FIGS. 3-5, are distributed radially symmetrically about a center of the combined cable 100. Specifically, there are two cables 10 in the embodiment shown in FIG. 3, four cables 10 in the embodiment shown in FIG. 4, and eight cables 10 in the embodiment shown in FIG. 5. However, it should be noted that those skilled in the art should understand that in some other embodiments of the present disclosure, the combined cable 100 may also include six cables 10, ten cables 10, etc., or may also include an odd number of cables 10, such as three cables 10, five cables 10, etc.

In the embodiment shown in FIG. 4, the combined cable 100 includes four cables 10, a filler 40 is disposed at the center of the combined cable 100, and the four cables 10 are distributed around the filler 40 located at the center.

In the embodiment shown in FIG. 5, the combined cable 100 includes eight cables 10, two of the eight cables 10 are located at the center of the combined cable 100, and the other six cables of the eight cables 10 are distributed around the two cables 10 located at the center of the combination cable 100.

It should be appreciated for those skilled in this art that the above embodiments are intended to be illustrative, and not restrictive. Many modifications may be made to the above embodiments by those skilled in this art, and various features described in different embodiments may be freely combined with each other without conflicting in configuration or principle. Although several embodiments have been shown and described, it would be appreciated by those skilled in the art that various changes or modifications may be made in these embodiments without departing from the principles and spirit of the disclosure, the scope of which is not limited to the implements of the example embodiments set forth in the specification.

What is claimed is:

1. A cable, comprising:
a pair of wires each having a conductor and a wire insulation layer wrapped around the conductor;
an inner insulation layer wrapped around the wire insulation layer of each of the wires and fixing the wires;
a metal shielding layer wrapped around an outer surface of the inner insulation layer, the metal shielding layer having an insulating substrate and a metal conductive layer coated on the insulating substrate; and
an outer insulation layer wrapped around an outer surface of the metal shielding layer, the metal conductive layer of the metal shielding layer facing the outer insulation layer.

2. The cable of claim 1, wherein the inner insulation layer is bonded to an outer surface of each of the wires.

3. The cable of claim 1, wherein the inner insulation layer is made of an insulating polymer material.

4. The cable of claim 3, wherein the inner insulation layer is made of polyethylene terephthalate.

5. The cable of claim 1, wherein the metal shielding layer is bonded to the outer surface of the inner insulation layer.

6. The cable of claim 5, wherein the metal conductive layer of the metal shielding layer is made of aluminum or copper.

7. The cable of claim 1, wherein the outer insulation layer is bonded to the outer surface of the metal shielding layer.

8. The cable of claim 1, wherein the outer insulation layer has a plurality of sub-insulating layers superimposed on one another.

9. The cable of claim 1, wherein the cable is flat.

10. A combined cable, comprising:
at least two cables, each of the at least two cables including:
a pair of wires each having a conductor and a wire insulation layer wrapped around the conductor,
an inner insulation layer wrapped around the wire insulation layer of each of the wires and fixing the wires,
a metal shielding layer wrapped around an outer surface of the inner insulation layer, the metal shielding layer having an insulating substrate and a metal conductive layer coated on the insulating substrate, and
an outer insulation layer wrapped around an outer surface of the metal shielding layer, the metal conductive layer of the metal shielding layer facing the outer insulation layer; and
an outer jacket located at an outermost portion of the combined cable.

11. The combined cable of claim 10, further comprising a shielding layer wrapped around the at least two cables.

12. The combined cable of claim 11, wherein the shielding layer has an inner shielding layer wrapped around the at least two cables and an outer shielding layer wrapped around the inner shielding layer.

13. The combined cable of claim 10, further comprising a filler filling at least a portion of a gap between the at least two cables.

14. The combined cable of claim 10, wherein the at least two cables are an even number of cables.

15. The combined cable of claim 14, wherein the at least two cables are distributed radially symmetrically about a center of the combined cable.

16. The combined cable of claim 14, wherein two of the at least two cables are located at a center of the combined cable.

17. The combined cable of claim 16, wherein a remainder of the at least two cables are distributed around the two cables at the center of the combined cable.

18. The combined cable of claim 15, further comprising a filler disposed at the center of the combined cable.
